(19) United States
(12) Patent Application Publication
(10) Pub. No.: US 2021/0041327 A1
(43) Pub. Date: Feb. 11, 2021

(54) SYSTEM AND METHOD FOR ACQUIRING VIBRATION-RELATED INFORMATION ASSOCIATED WITH OPERATION OF A ROTARY MACHINE

(71) Applicant: Caterpillar Inc., Deerfield, IL (US)

(72) Inventor: Samuel James Boston, Peoria, IL (US)

(73) Assignee: Caterpillar Inc., Deerfield, IL (US)

(21) Appl. No.: 16/534,516

(22) Filed: Aug. 7, 2019

(51) Int. Cl. G01M 13/045; G01H 1/00; G05B 23/02; G07C 3/06

(52) U.S. Cl. CPC G01M 13/045; G07C 3/06; G05B 23/0256; G01H 1/006

(57) ABSTRACT

A system for acquiring vibration-related information associated with operation of a rotary machine may include a case configured to contain therein, and facilitate access to, components of the system. The system may also include a sensor configured to be detachably coupled to the rotary machine and generate a signal indicative of vibrations related to operation of the rotary machine. The system may also include a supervisor module in communication with the sensor and configured to generate an acceleration signal. The system may further include a subordinate module in communication with the supervisor module and the sensor and configured to generate a second acceleration signal. The supervisor module may be configured to provide operation instructions to the subordinate module, receive the second acceleration signal from the subordinate module, and communicate image data indicative of the first acceleration signal and the second acceleration signal to an output device.

### TECHNICAL FIELD

The present disclosure relates to a system and method for acquiring vibration-related information associated with operation of a rotary machine, and more particularly, to a portable system and method for acquiring vibration-related information associated with operation of a rotary machine.

### BACKGROUND

Early detection of a mechanical problem with a machine may reduce the likelihood, or prevent, more significant and/or more costly damage to the machine. For example, failure of a particular component of a machine may result in damage to additional components of the machine. Thus, if a problem with the particular component is identified prior to its failure, it may reduce or prevent damage to the additional components of the machine, thereby reducing down time and/or repair costs. Moreover, for the purpose of identifying potential problems before component failure occurs, it may be necessary for inspection of the machine at a service location remote from where the machine is being used. However, it may not be practical, or it may be costly and time consuming, for some types of machines to be transported to a service location remote from a location where the machine is being used. For example, when the machine is large or must be placed on a trailer or cargo carrier to be transported to a service location for evaluation of the condition of the machine, it may be prohibitively costly or time consuming to do so. As a result, it may be desirable to develop a way to evaluate operation of a machine to identify potential problems with the machine prior to failure of major components of the machine, and in addition, to make such evaluations at the location at which the machine is being operated.

An attempt to provide a portable data acquisition system is described in U.S. Patent Application Publication No. US 2005/0262221 A1 to Daniels et al. (“the '221 publication”), published Nov. 24, 2005. Specifically, the '221 publication describes a compact data acquisition unit modularly assembled from commercial-off-the-shelf components. According to the '221 publication, inside a casing, a DC-to-DC converter increases battery-generated DC voltage for a computer processor that communicates with storage/memory and collects sensory information via an analogue-to-digital converter. The data acquisition unit can be implemented with sensory instrumentation. A device, remotely placed, that includes a data acquisition unit, one or more sensors, and a pod containing the unit and the one or more sensors, may be communicated with wirelessly.

Although the '221 publication purports to describe a data acquisition system including one or more sensors, the '221 publication does not describe a system and method for identifying potential or actual problems associated with rotary machines or a portable system and method for acquiring vibration-related information associated with operation of a rotary machine. The systems and methods disclosed herein may be directed to addressing one or more of the possible concerns set forth above.

### SUMMARY

According to a first aspect, a system for acquiring vibration-related information associated with operation of a rotary machine may include a portable case configured to contain therein, and facilitate access to, components of the system. The system may include a first sensor configured to be detachably coupled to a rotary machine and generate a first signal indicative of vibrations related to operation of the rotary machine. The system may further include a supervisor module in communication with the first sensor and configured to receive the first signal indicative of vibrations related to operation of the rotary machine, and generate a first acceleration signal based at least in part on the first signal indicative of vibrations related to operation of the rotary machine. The system may also include a second sensor configured to be detachably coupled to the rotary machine and generate a second signal indicative of vibrations related to operation of the rotary machine. The system may also include a first subordinate module in communication with the supervisor module and the second sensor. The first subordinate module may also be configured to receive the second signal indicative of vibrations related to operation of the rotary machine and generate a second acceleration signal based at least in part on the second signal indicative of vibrations related to operation of the rotary machine. The system may further include a third sensor configured to be detachably coupled to the rotary machine and generate a third signal indicative of vibrations related to operation of the rotary machine. The system may further include a second subordinate module in communication with the supervisor module and the third sensor and configured to receive the third signal indicative of vibrations related to operation of the rotary machine. The second subordinate module may also be configured to generate a third acceleration signal based at least in part on the third signal indicative of vibrations related to operation of the rotary machine. The system may also include an output device in communication with the supervisor module. The supervisor module may be configured to provide operation instructions to the first subordinate module and to the second subordinate module. The supervisor module may also be configured to receive the second acceleration signal from the first subordinate module and the third acceleration signal from the second subordinate module, and communicate image data indicative of the first acceleration signal, the second acceleration signal, and the third acceleration signal to the output device.

According to a further aspect, a system for acquiring vibration-related information associated with operation of a rotary machine may include a case configured to contain therein, and facilitate access to, components of the system. The system may also include a sensor configured to be detachably coupled to a rotary machine and generate a signal indicative of vibrations related to operation of the rotary machine. The system may also include a supervisor module in communication with the sensor and configured to receive the signal indicative of vibrations related to operation of the rotary machine. The supervisor module may also be configured to generate a first acceleration signal based at least in part on the signal indicative of vibrations related to operation of the rotary machine. The system may also include a subordinate module in communication with the supervisor module and the sensor and configured to receive the signal indicative of vibrations related to operation of the rotary machine. The subordinate module may also be configured to generate a second acceleration signal based at least in part on the signal indicative of vibrations related to operation of the rotary machine. The system may also include an output device in communication with the supervisor module. The supervisor module may be configured to provide operation instructions to the subordinate module. The supervisor module may also be configured to receive the second acceleration signal from the subordinate module and communicate image data indicative of the first acceleration signal and the second acceleration signal to the output device.

According to another aspect, a method for acquiring vibration-related information associated with operation of a rotary machine may include opening a portable case containing a supervisor module, a first subordinate module, a second subordinate module, a first sensor, a second sensor, and a third sensor. The method may also include withdrawing the first sensor, the second sensor, and the third sensor from the case, and coupling the first sensor, the second sensor, and the third sensor to a rotary machine. The method may further include receiving by the supervisor module, from the first sensor, a first signal indicative of vibrations related to operation of the rotary machine, receiving by the first subordinate module, from the second sensor, a second signal indicative of vibrations related to operation of the rotary machine, and receiving by the second subordinate module, from the third sensor, a third signal indicative of vibrations related to operation of the rotary machine. The method may also include generating a first acceleration signal, a second acceleration signal, and a third acceleration signal, respectively, via the supervisor module, the first subordinate module, and the second subordinate module. The method may further include displaying, based at least in part on the first acceleration signal, the second acceleration signal, and the third acceleration signal, an image providing at least one of a graphical representation of vibration associated with operation of the rotary machine or a tabular representation of vibration associated with operation of the rotary machine.

### BRIEF DESCRIPTION OF THE DRAWINGS

The detailed description is described with reference to the accompanying figures. In the figures, the left-most digit of a reference number identifies the figure in which the reference number first appears. The same reference numbers in different figures indicate similar or identical items.

FIG. 1 is a block diagram of an example system for acquiring vibration-related information associated with an example rotary machine.

FIG. 2 is a schematic perspective view of an example case of an example system for acquiring vibration-related information associated with an example rotary machine, with the case in a closed condition.

FIG. 3 is a schematic perspective view of the example case shown in FIG. 2, with the case in an open condition permitting access to at least some components of the system.

FIG. 4 is a schematic perspective view of the example case shown in FIG. 2, with the case in an open condition and example communications cables coupled to example modules of the system.

FIG. 5 is a schematic perspective view of the example case shown in FIG. 2, with the case in an open condition and example communications cables separated from the case to expose an example communications hub, an example user input device, and example batteries contained in the case.

FIG. 6 is a schematic perspective view of the example case shown in FIG. 2, with the case in an open condition and an example user input device removed from the case for use and coupled to one of the example modules via an example communications cable.

FIG. 7 is an example of a graphical representation of vibration-related information associated with operation of an example rotary machine.

FIG. 8 illustrates a flow diagram of an example process for acquiring vibration-related information associated with operation of a rotary machine.

### DETAILED DESCRIPTION

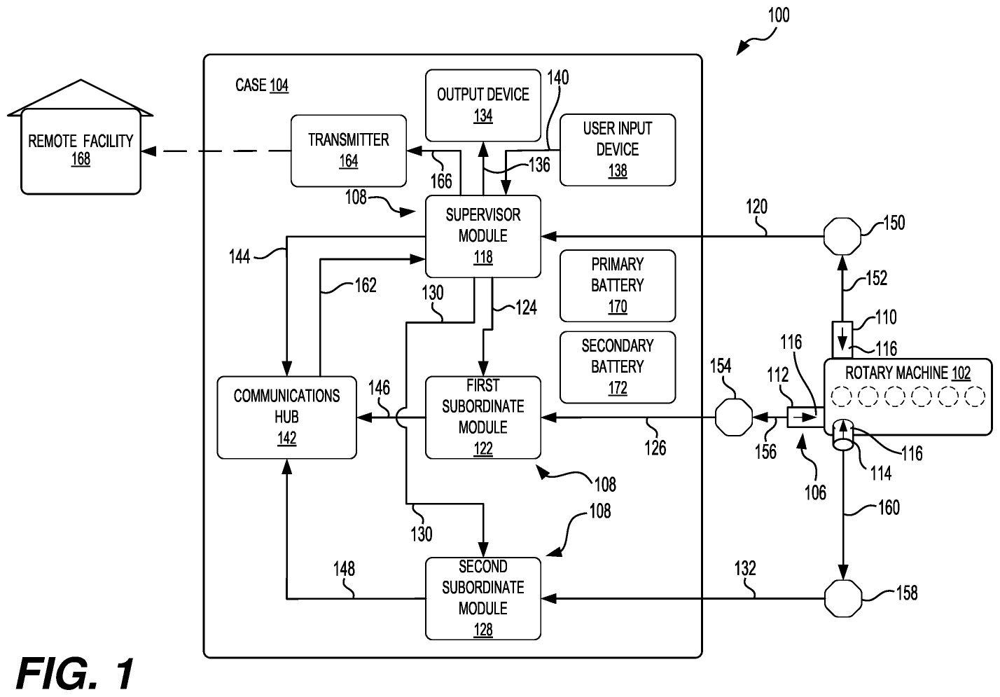

FIG. 1 is a block diagram of an example system 100 for acquiring vibration-related information associated with an example rotary machine 102. For example, system 100 may be portable and may be configured to facilitate on-site data acquisition and/or testing of rotary machine 102. In some examples, system 100 may include a case 104 configured to contain, and facilitate access to, one or more components of system 100 for deployment to facilitate acquiring vibration-related data during operation of rotary machine 102. In some examples, case 104 may be sufficiently lightweight and/or compact for a person to transport system 100 to a location at which rotary machine 102 is present for acquisition of vibration-related data on-site, for example, as explained herein. Rotary machine 102 may be, or include, any machine including one or more components that rotate during operation, such as, for example, a reciprocating-piston internal combustion engine, a gas turbine engine, an electric generator, an electric motor, a compressor, or a pump. As explained herein, system 100 may include one or more sensors configured to be associated with (e.g., coupled to, for example, coupled directly to) one or more portions of rotary machine 102 and generate one or more signals indicative of vibrations associated with rotary machine 102, for example, during operation of rotary machine 102. In some examples, system 100 may facilitate identification of one or more potential faults (e.g., rotational imbalance, component fracture, component wear, and/or excessive heat build-up) associated with one or more components of rotary machine 102, for example, as explained herein.

In the example shown in FIG. 1, system 100 includes sensors 106 configured to be associated with (e.g., coupled to, for example, coupled directly to) rotary machine 102 and modules 108 in communication with each of the sensors 106. For example, the system 100 shown in FIG. 1 includes a first sensor 110, and second sensor 112, and a third sensor 114, each configured to be detachably coupled to rotary machine 102 and generate one or more signals indicative of vibrations related to operation of rotary machine 102. In some examples, one or more of first sensor 110, second sensor 112, or third sensor 114 may be, or include, an accelerometer (e.g., a single-axis accelerometer) configured to generate a voltage indicative of the acceleration of rotary machine 102 at the point at which each of the respective sensors 110, 112, and/or 114 is coupled to rotary machine 102. Other numbers and/or types of sensors are contemplated. In some examples, a sensor housing 116 may be coupled to one or more of sensors 110, 112, and/or 114, and in some examples, sensor housing 116 may include a coupling device configured to couple the one or more sensors 110, 112, and/or 114 to rotary machine 102. For example, the coupling device may be, or include, a magnetic coupler configured to detachably couple the one or more sensor housings 116 and one or more sensors 110, 112, and/or 114 to rotary machine 102. Other numbers and/or types of coupling devices are contemplated. In some examples, first sensor 110, second sensor 112, and/or third sensor 114 may be coupled to rotary machine, such that they generate signals indicative of vibration-related information associated with rotary machine 102 in two and/or three mutually orthogonal axes, such as, for example, X-, Y-, and/or Z-axes. In this example manner, two or three single-axis accelerometers may be configured to generate signals indicative of vibration-related information in two or three axes.

Although the example system 100 described herein includes one or more sensors configured to generate signals indicative of vibrations related to operation of a rotary machine, it is contemplated that system 100 may include additionally, or alternatively, one or more sensors configured to generate signals indicative of other parameters related to a rotary machine. For example, other types of sensors may be used to identify the one or more components of the rotary machine that are experiencing an approaching and/or existing fault and/or failure. For example, one or more of the sensors may include a sensor configured to generate one or more signals indicative of a sound related to operation of the rotary machine, and the signals indicative of sound may be used to at least assist with identification of components of the rotary machine experiencing an approaching and/or existing fault and/or failure. For example, a sensor configured to generate signals indicative of sound may be used to assist with identifying that a valve of an internal combustion engine is contacting a piston of the internal combustion engine during operation, which may be an indication of a fault with a corresponding valve spring, the valve, and/or the corresponding piston.

In the example shown in FIG. 1, modules 108 include a supervisor module 118 in communication with first sensor 110 via, for example, a first communications cable 120. Supervisor module 118 may be configured to receive one or more signals indicative of vibrations related to operation of rotary machine 102 and generate one or more first acceleration signals based at least in part on the one or more first signals indicative of vibrations related to operation of rotary machine 102. For example, supervisor module 118 may receive one or more voltage signals generated by first sensor 110 and may convert the one or more voltage signals into one or more corresponding first acceleration signals indicative of vibrations associated with operation of rotary machine 102 at the point at which first sensor 110 is coupled to rotary machine 102. In the example shown, system 100 also includes a first subordinate module 122 in communication with supervisor module 118 via, for example, a communications cable 124 and second sensor 112 via, for example, a second communications cable 126. First subordinate module 122 may be configured to receive one or more second signals indicative of vibrations related to operation of rotary machine 102 and generate one or more second acceleration signals based at least in part on the one or more second signals indicative of vibrations related to operation of rotary machine 102. For example, first subordinate module 122 may receive one or more voltage signals generated by second sensor 112 and may convert the one or more voltage signals into one or more corresponding second acceleration signals indicative of vibrations associated with operation of rotary machine 102 at the point at which second sensor 112 is coupled to rotary machine 102. The example system 100 shown in FIG. 1 also includes a second subordinate module 128 in communication with supervisor module 118 via, for example, a communications cable 130, and third sensor 114 via, for example, a third communications cable 132. Second subordinate module 128 may be configured to receive one or more third signals indicative of vibrations related to operation of rotary machine 102 and generate one or more third acceleration signals based at least in part on the one or more third signals indicative of vibrations related to operation of the rotary machine 102. For example, second subordinate module 128 may receive one or more voltage signals generated by third sensor 114 and may convert the one or more voltage signals into one or more corresponding third acceleration signals indicative of vibrations associated with operation of rotary machine 102 at the point at which third sensor 114 is coupled to rotary machine 102. Although the example system 100 shown in FIG. 1 includes communications cables providing communication between sensors 106 and modules 108, one or more of the communications cables may be supplemented or replaced by wireless communication operating according to, for example, any known wireless communication protocol(s).

Different numbers of sensors 106 and/or modules 108 are contemplated. For example, some examples of system 100 are scalable to include more sensors 106 and/or modules 108. For example, system 100 may include additional subordinate modules and additional sensors 106 coupled to the additional subordinate modules. In some such examples, the additional subordinate modules may be in communication with supervisor module 118, which may at least partially control operation of one or more of the additional subordinate modules, for example, as described herein. This may permit data acquisition by additional sensors.

As shown in FIG. 1, some examples of system 100 may include an output device 134 in communication with supervisor module 118. Output device 134 may include, for example, a display device and/or an audio output device configured to display and or communicate vibration-related information associated with rotary machine 102. For example, output device 134 may be coupled via a communications cable 136 (and/or wirelessly) to supervisor module 118. In some examples, supervisor module 118 may be configured to receive the one or more second acceleration signals from first subordinate module 122 (directly and/or indirectly) and the one or more third acceleration signals from second subordinate module 128 (directly and/or indirectly), and communicate image data indicative of the one or more first acceleration signals, the one or more second acceleration signals, and/or the one or more third acceleration signals to output device 134 for display and/or audio communication, for example, as explained herein. For example, the image data indicative of the one or more first acceleration signals, the one or more second acceleration signals, and/or the one or more third acceleration signals may be indicative of a graphical representation of vibration associated with operation of rotary machine 102 and/or a tabular representation of vibration associated with operation of rotary machine 102. For example, output device 134 may be a display device, and the display device may display a graphical representation of the vibration-related information (e.g., acceleration versus frequency of vibration) and/or one or more tables including numeric values corresponding to the vibration-related information (e.g., tables including acceleration values and corresponding frequency values).

As shown in FIG. 1, some examples of system 100 may include a user input device 138 configured to facilitate communication between an operator of system 100 and system 100. For example, user input device 138 may include a keyboard, a mouse, a touchpad, and/or a voice-recognition entry device activating and/or controlling operation of system 100. For example, user input device 138 may be coupled via a communications cable 140 (and/or wirelessly) to supervisor module 118. In some examples, user input device 138 may be configured to facilitate selection of either a standard operation mode or a user-defined operation mode (or a combination of both modes). For example, the standard operation mode may include operation by system 100 according to a predetermined testing duration, a predetermined testing delay, a predetermined test frequency, and/or a predetermined voltage offset. In some examples, the user-defined operation mode may provide a user with an ability to set a user-defined testing duration, a user-defined testing delay, a user-defined test frequency, and/or a user-defined voltage offset, which may facilitate selection by the user of a customized data acquisition procedure, which may be desirable for use on certain types and/or sizes of rotary machines. For example, according to the standard operating mode, once the user opens case 104 to access the components of system 100, the user may activate system 100, for example, by pushing an “On/Off” button and/or performing another similar procedure, after which output device 134 may display notification of activation and/or a status of system 100. In some examples, output device 134 may provide a graphical user interface displaying an option to select either the standard operation mode or a user-defined operation mode. In some examples, if the standard operation mode is selected, output device 134 may provide instructions to the user for removing one or more components of system 100 from case 104 (e.g., one or more of sensors 106 and/or associated communications cables), and coupling the one or more components to one another and to rotary machine 102 (e.g., coupling one or more of the communications cables to one or more of the sensors 106, and coupling one or more of the sensors 106 to rotary machine 102). In some examples, following the deployment and coupling of the components, output device 134 may communicate a prompt to begin data acquisition, for example, by providing a virtual “START” button that may be selected using user input device 138. In the user-defined operation mode, output device 134 may provide a sequence of prompts for a user of system 100 to set one or more data acquisition parameters, such as, for example, a user-defined testing duration, a user-defined testing delay, a user-defined test frequency, and/or a user-defined voltage. Other user-defined parameters are contemplated.

As noted above, supervisor module 118 may be in communication with first subordinate module 122 and/or second subordinate module 128, either directly or indirectly, and supervisor module 118 may be configured to provide operation instructions to first subordinate module 122 and/or second subordinate module 128. For example, as shown in FIG. 1, supervisor module 118 is in direct communication with first subordinate module 122 and second subordinate module 128 via communications cables 124 and 130, respectively. In some examples, supervisor module 118 may be programmed to control acquisition of the vibration-related information associated with rotary machine 102, and the programming of supervisor module 118 may be configured to provide operation instructions to first subordinate module 122 and/or second subordinate module 128, for example, according to a relationship sometimes referred to as a “master/slave” relationship, so that first subordinate module 122 and/or second subordinate module 128 receive the one or more signals generated by, for example, second sensor 112 and/or third sensor 114, respectively, and convert the one or more signals into one or more signals indicative of acceleration associated with vibration of rotary machine 102, for example, during operation of rotary machine 102. For example, the operation instructions communicated to first subordinate module 122 and/or second subordinate module 128 may include a timestamp for temporally aligning the one or more first signals, the one or more second signals, and/or the one or more third signals from the first sensor 110, the second sensor 112, and/or the third sensor 114, respectively.

In some examples, supervisor module 118 may create a data file in a specified folder with the timestamp of the test start to distinguish between tests. In some examples, supervisor module 118 may communicate a version of the program it is executing to first subordinate module 122 and/or second subordinate module 128, which may thereafter execute with parameters according to the standard operation mode and/or as defined by the user in the user-defined operation mode. In some such examples, each of supervisor module 118, first subordinate module 122, and/or second subordinate module 128 may determine vibration-related information (e.g., vibration measured by the one or more sensors), for example, by storing output voltages of the respective sensors and converting the output voltages into acceleration signals (e.g., in the form a fractions and/or multiples of the force due to gravitational pull (“Gs”). In some such examples, data from one or more of (e.g., each of) supervisor module 118, first subordinate module 122, or second subordinate module 128 may be input into an array, and the resulting arrays may thereafter be combined into a single array. Such example arrays may be used and/or manipulated to, for example, calculate and/or display via output device 134 values of interest derived from the original data generated by the one or more sensors. For example, output device 134 may display and/or communicate a single graph including one, two, or three results derived from the sensor signals generated by the one or more sensors as separate plot lines, a table providing, for example, mean, median, and a square-root average of the data, a graph including a single plot line in greater detail, and/or additional information of interest derivable from the sensor data.

In some examples, one or more of supervisor module 118, first subordinate module 122, or second subordinate module 128 may be, or include, any type of microcomputer suitable for performing the operations described herein. For example, supervisor module 118, first subordinate module 122, and/or second subordinate module 128 may be, or include, a small single-board computer, such as, for example, those marketed under the RASPBERRY PI® trademark. Other types of computing devices are contemplated.

In some examples, one or more of supervisor module 118, first subordinate module 122, or second subordinate module 128 may include, and/or be in communication with, a real-time clock configured to maintain an accurate time stamp for the respective supervisor module 118, first subordinate module 122, and/or second subordinate module 128, for example, even when supervisor module 118, first subordinate module 122, and/or second subordinate module 128 is/are not in communication with a network, such as, for example, the internet. In some such examples, the one or more real-time clocks may be included in case 104 and, in some examples, each of the one or more real-time clocks may be electrically coupled to a power source, for example, a battery (e.g., a button battery) for each of the one or more real-time clocks. In some examples, the one or more real-time clocks may be electrically coupled to the one or more power sources, either directly or via, for example, respective data acquisition modules, such as, for example, the data acquisition modules described herein.

One or more of supervisor module 118, first subordinate module 122, or second subordinate module 128 may include one or more processors, which may execute any modules associated with supervisor module 118, first subordinate module 122, and/or second subordinate module 128 to cause supervisor module 118, first subordinate module 122, and/or second subordinate module 128 to perform a variety of functions, as set forth above and explained in further detail herein. In some examples, the processor(s) may include a central processing unit (CPU), a graphics processing unit (GPU), both CPU and GPU, or other processing units or components known in the art. Additionally, each of the processors may possess its own local memory, which also may store program modules, program data, and/or one or more operating systems.

Computer-readable media associated with supervisor module 118, first subordinate module 122, and/or second subordinate module 128 may include volatile memory (e.g., RAM), non-volatile memory (e.g., ROM, flash memory, miniature hard drive, memory card, or the like), or some combination thereof. The computer-readable media may be non-transitory computer-readable media. The computer-readable media may include or be associated with the one or more of the above-noted modules, which perform various operations associated with supervisor module 118, first subordinate module 122, and/or second subordinate module 128. In some examples, one or more of the above-noted modules may include or be associated with computer-executable instructions that are stored by the computer-readable media and that are executable by one or more processors to perform such operations. Supervisor module 118, first subordinate module 122, and/or second subordinate module 128 may also include additional components not listed above that may perform any function associated with supervisor module 118, first subordinate module 122, and/or second subordinate module 128. Supervisor module 118, first subordinate module 122, and/or second subordinate module 128 may communicate with one another using any known wired and/or wireless communication protocols and/or networks.

As shown in FIG. 1, some examples of system 100 may include a communications hub 142, such as, for example, an ethernet hub, and supervisor module 118, first subordinate module 122, and/or second subordinate module 128 may be coupled (e.g., indirectly) to one another via communications hub 142. For example, a communications cable 144 provides communication between supervisor module 118 and communication hub 142, a communications cable 146 provides communication between first subordinate module 122 and communication hub 142, and a communications cable 148 provides communication between second subordinate module 128 and communication hub 142. In some examples, system 100 also includes a first data acquisition module 150 in communication with first sensor 110, for example, via a communications cable 152, and supervisor module 118, for example, via communications cable 120. Example system 100 also includes a second data acquisition module 154 in communication with second sensor 112, for example, via a communications cable 156, and first subordinate module 122, for example, via communications cable 126. Example system 100 also includes and a third data acquisition module 158 in communication with third sensor 114, for example, via a communications cable 160, and second subordinate module 128, for example, via communications cable 132. In some examples, first data acquisition module 150, second data acquisition module 154, and/or third data acquisition module 158 may be configured to regulate power associated with first sensor 110, second sensor 112, and/or third sensor 114, respectively, and/or regulate frequencies at which first sensor 110, second sensor 112, and/or third sensor 114 generate, respectively, the one or more first signals, the one or more second signals, and/or the one or more third signals.

Thus, in the example shown in FIG. 1, signals from first sensor 110, second sensor 112, and third sensor 114 are communicated to first data acquisition module 150, second data acquisition module 154, and third data acquisition module 158, respectively. Signals from first data acquisition module 150, second data acquisition module 154, and third data acquisition module 158 are communicated to supervisor module 118, first subordinate module 122, and second subordinate module 128, respectively. As explained herein, supervisor module 118, first subordinate module 122, and second subordinate module 128 convert the signals received from first sensor 110, second sensor 112, and third sensor 114 into acceleration signals, which are respectively communicated to communications hub 142, and thereafter communicated to supervisor module 118, for example, via communications cable 144 and/or a communications cable 162. As explained herein, supervisor module 118 may manipulate and/or use the signals received from communications hub 142 to generate image data including the vibration-related data of interest, which may be communicated via communications cable 136 to output device 134, for example, for display.

In some examples, for example, as shown in FIG. 1, system 100 may include a transmitter 164 in communication with supervisor module 118, for example, via a communications cable 166. Transmitter 164 may be configured to transmit the image data, the one or more first acceleration signals, the one or more second acceleration signals, and/or the one or more third acceleration signals to, for example, a remote facility 168 at a location remote from case 104. In some examples, remote facility 168 may include, for example, a maintenance facility at the worksite at which rotary machine 102 is located, a maintenance facility at a geographic location remote from the worksite, and/or a service center associated with the manufacturer and/or distributer from which rotary machine 102 was obtained. The transmission may be via one or more communications cables, one or more communications networks, and/or via wireless communication, for example, according to wireless communication protocols.

As shown in FIG. 1, some examples of system 100 may include a primary battery 170 configured to supply electrical power to system 100 from within case 104, for example, so that system 100 may be used in an environment without access to an external electrical power source, such as, for example, at a worksite such as a construction site or mining site. As shown, some examples of system 100 may also include a secondary battery 172 configured to supply electrical power to system 100 from within case 104, for example, for use as a back-up to primary battery 170 when a level of charge of primary battery 170 drops below a threshold level of charge. In some examples, secondary battery 172 may have the same, or similar, capacity as primary battery 170. In some examples, secondary battery 172 may have a relatively smaller capacity than primary battery 170, for example, such that when the level of charge of primary battery 170 falls below a threshold level, system 100 switches from primary battery to 170 to secondary battery 172, which provides enough electrical power to save data acquired during operation of system 100, for example, prior to deactivating system 100. Thereafter, system 100 may be activated again for acquiring vibration-related information using an external power source and/or primary battery 170 following replacement or recharging.

In some examples of system 100, system 100 may be configured to facilitate identification of differences between vibration-related data associated with prior-in-time operation of rotary machine 102 and the one or more first acceleration signals, the one or more second acceleration signals, and/or the one or more third acceleration signals. For example, system 100 may be configured to access memory, integrated into system 100 (e.g., contained within case 104) and/or remote from system 100, configured to store vibration-related data associated with prior-in-time operation of rotary machine 102. In some examples, such differences may be an indication of a potential fault, a worsening fault, and/or a failure of one or more components of rotary machine 102. For example, a difference in vibration-related data during operation of rotary machine 102 may be an indication of an impending failure of a bearing, an insufficiency of lubrication and/or cooling in rotary machine 102, a rotating imbalance due, for example, to component wear and/or fracture, and/or a crack in one or more components of rotary machine 102. In examples configured to access memory, the memory may contain data recorded during fault-free operation of rotary machine 102 (e.g., operation according to specification), and thus, differences may be an indication of a potential, impending, and/or actual fault with one or more components of rotary machine 102.

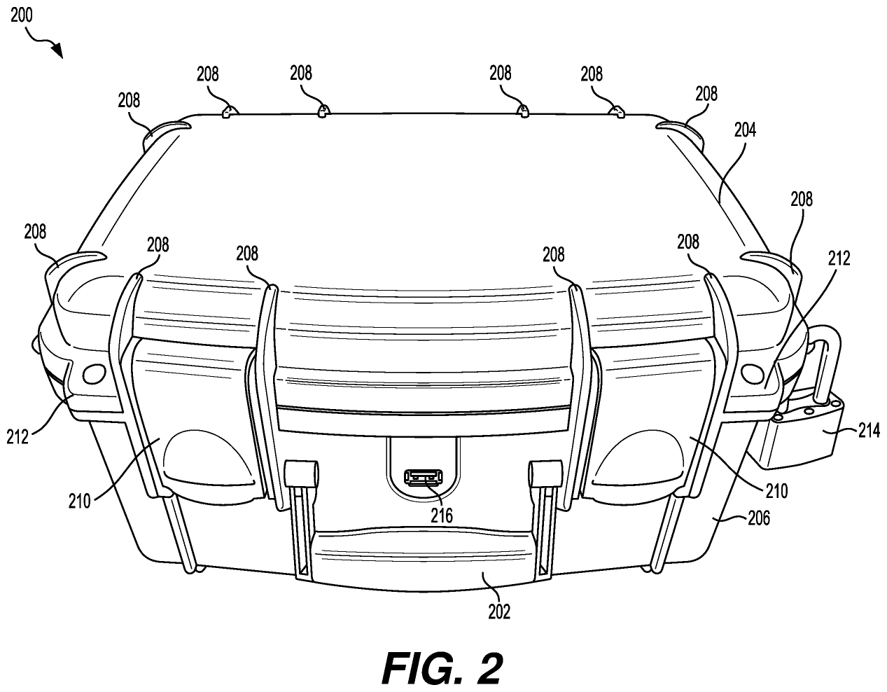

FIG. 2 is a schematic perspective view of an example case 200 of an example system 100 for acquiring vibration-related information associated with an example rotary machine, with example case 200 in a closed condition. Example case 200 may correspond to example case 104 shown in FIG. 1. As shown in FIG. 2, case 200 may be configured to be portable, for example, being sufficiently lightweight and/or compact for a person to carry case 200 and its contents (e.g., components of system 100) to a location remote from an external electrical power source, such as a worksite (e.g., a construction worksite and or mining worksite). Some examples of case 200 may include a handle 202 to facilitate carrying of case 200 by a person. In some examples, case 200 may include one or more wheels and/or or an extendable handle (e.g., similar to luggage) to render case 200 more easily movable/portable. In some examples, case 200 may be portable and configured to be transported using the assistance of a cart, a trailer, or similar conveyance device.

As shown in FIG. 2, case 200 may include an upper shell 204 and a lower shell 206 defining an interior volume within which components of system 100 may be received and transported. Some examples of case 200 may include one or more gussets 208 in order to improve the rigidity of upper shell 204 and/or lower shell 206. Some examples of case 200 may also include one or more latches 210 configured to secure case 200 in a closed condition, as shown in FIG. 2. In some examples, case 200 may include one or more bosses 212 on upper shell 204 and/or lower shell 206 configured to receive a securing device 214, such as, for example, a lock (e.g., a padlock) to secure case 200 in the closed condition. In addition, some examples of case 200 may include a port 216 configured to provide an electrical connection between an external electrical power source and one or more components of system 100, such as, for example, primary battery 170 and/or secondary battery 172 (see FIG. 1). This may permit operation of system 100 using the external power source and/or charging one or more of primary battery 170 or secondary battery 172. Other forms of case 200 are contemplated.

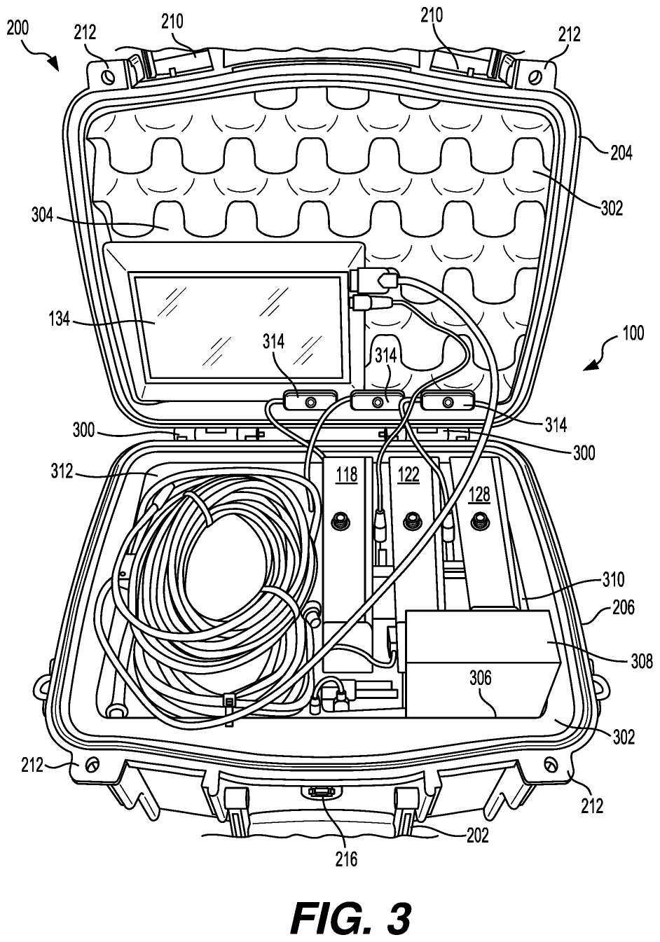

FIG. 3 is a schematic perspective view of example case 200 shown in FIG. 2, with case 200 in an open condition permitting access to at least some components of system 100. As shown, case 200 includes a pair of hinges 300 configured to provide upper shell 204 and lower shell 206 with an ability to pivot with respect to one another to open case 200, for example, in a clam-shell manner, to gain access to components of system 100, as shown in FIG. 3. Some examples of upper shell 204 and lower shell 206 may be configured to separate completely from one another.

As shown in FIG. 3, the interior of upper shell 204 and/or lower shell 206 may include a cushioning material 302 (e.g., foam) configured to prevent damage to one or more components of system 100 during storage and/or transport of case 200. As shown in FIG. 3, the interior of example case 200 may be compartmentalized for receipt and storage of various components of system 100. Some components may not be viewable in FIG. 3. In the example shown, the interior of upper shell 204 and/or cushioning material 302 includes recess 304 configured to receive output device 134 (e.g., a display device) therein, for example, such that when upper shell 204 is opened, output device 134 may be viewable by a user of system 100. Communications cable 136 may provide a communication link between out device 134 and supervisor module 118. In the example shown, interior of lower shell 206 and/or cushioning material 302 may include a recess 306 configured to receive a storage compartment 308 configured to receive, for example, tools, spare parts, and/or other parts related to operation of system 100. The interior of example lower shell 206 and/or cushioning material 302 also includes a recess 310 configured to receive therein one or more of supervisor module 118, first subordinate module 122, or second subordinate module 128. In some examples, one or more of supervisor module 118, first subordinate module 122, or second subordinate module 128 may be releasably secured in recess 310, for example, for removal. Example interior of lower shell 206 and/or cushioning material 302 also includes a recess 312 for receipt of one or more communications cables of system 100. As shown in FIG. 3, one or more power buttons 314 may also be provided in the interior of case 200, for example, for activating and deactivating one or more of supervisor module 118, first subordinate module 122, second subordinate module 128, communications hub 142 (see FIG. 1), or output device 134.

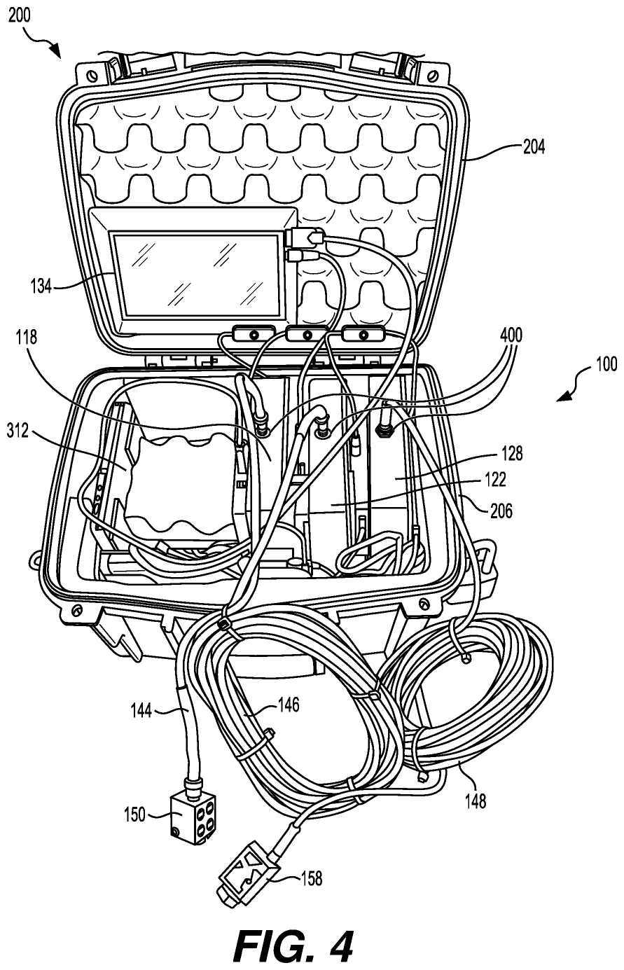

FIG. 4 is a schematic perspective view of example case 200 shown in FIGS. 2 and 3, with case 200 in an open condition and supervisor module 118, first subordinate module 122, and second subordinate module 128 communicatively coupled, respectively, to first data acquisition module 150, second data acquisition module 154, and third data acquisition module 158 via communications cables 144, 146, and 148, respectively. (In FIG. 4, second data acquisition module 154 is obscured from view via communications cables 144 and 146.) In the example shown, each of supervisor module 118, first subordinate module 122, and second subordinate module 128 includes a port 400 configured to receive communications cables 144, 146, and 148, respectively. Thus, when using system 100, communications cables 144, 146, and 148, stored in recess 312, may be removed from recess 312 and coupled, respectively, to supervisor module 118, first subordinate module 122, and second subordinate module 128. In some examples, one or more of the communications cables 144, 146, and 148 may be color-coded and one or more of the ports 400 may be color-coded to facilitate ease of connection, for example, during an on-site set-up of system 100 by untrained personnel. In some examples, first data acquisition module 150, second data acquisition module 154, and third data acquisition module 158 may be coupled to communications cables 144, 146, and 148, respectively, and first sensor 110, second sensor 112, and third sensor 114 (see FIG. 1) may be coupled, respectively, to first data acquisition module 150, second data acquisition module 154, and third data acquisition module 158 via communications cables 152, 156, and 160.

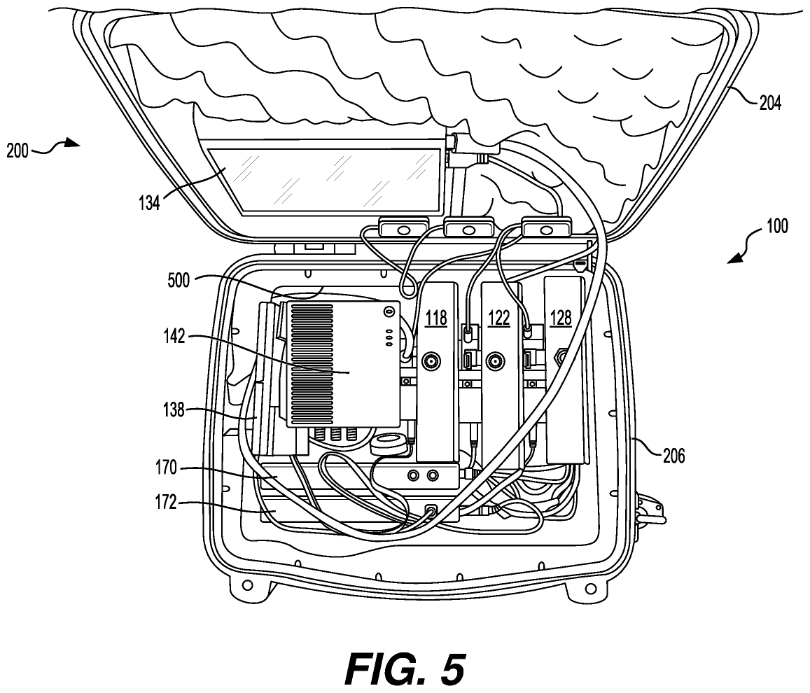

FIG. 5 is a schematic perspective view of example case 200 shown in FIGS. 2-4, with case 200 in an open condition and example communications cables separated from case 200 to expose example communications hub 142, example user input device 138, example primary battery 170, and example secondary battery 172 contained in case 200. For example, the interior of lower shell 206 and/or cushioning material 302 defines a recess 500 configured receive therein communications hub 142, user input device 138 (e.g., a compact or folding keyboard, mouse, and/or touchpad), primary battery 170, and secondary battery 172.

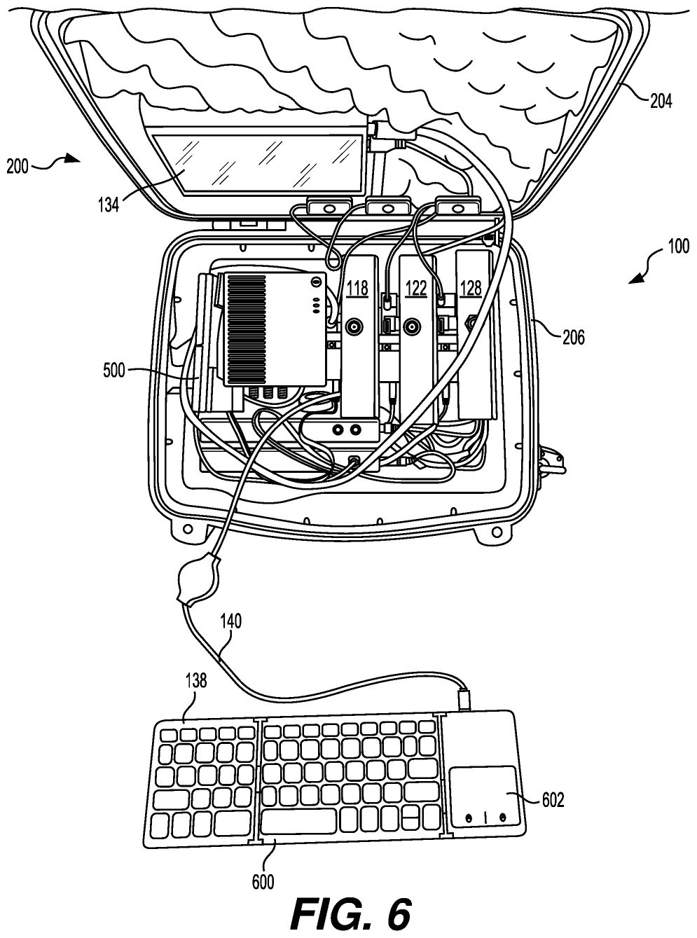

FIG. 6 is a schematic perspective view of example case 200 shown in FIGS. 2-5, with case 200 in an open condition and example user input device 138 removed from case 200 for use and coupled to example supervisor module 118 via example communications cable 140. As shown in FIG. 6, example user input device 138 has been removed from recess 500 of case 200 for use (see FIG. 5). Unser input device 138 has been communicatively coupled to supervisor module 118 via communications cable 140. Example user input device 138 is, or includes, a folding keyboard 600 having an integrated touchpad 602. Other forms of user input device are contemplated. As shown in FIG. 6, with case 200 in the open condition, a user may use user input device 138 to enter information and view information associated with operation of system 100 via output device 134.

Other configurations of recesses and/or storage arrangements for components of system 100 are contemplated. In some examples, one or more of the communications cables may be supplemented or replaced with wireless communications, for example, according to known wireless communications protocols.

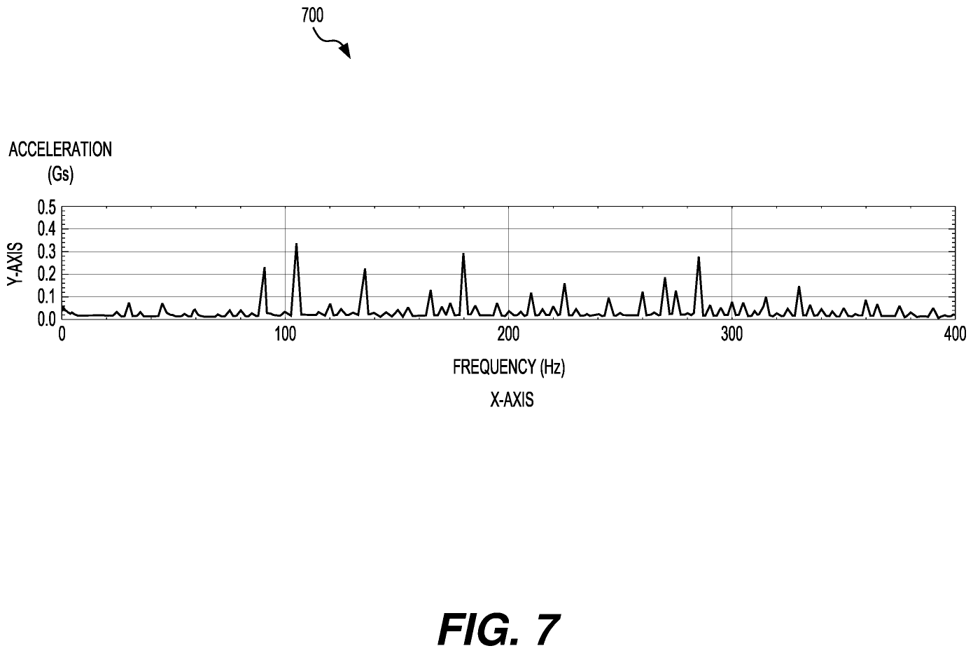

FIG. 7 is an example of a graphical representation 700 of vibration-related information associated with operation of an example rotary machine. As shown in FIG. 7, some examples of system 100 may be configured to convert image data indicative of one or more of the first acceleration signals, one or more of the second acceleration signals, and/or one or more of the third acceleration signals into a graphical representation of vibration-related information associated with operation of a rotary machine and/or a tabular representation of vibration-related information associated with operation of the rotary machine. For example, output device 134 may be a display device, and the display device may display a graphical representation of the vibration-related information (e.g., acceleration versus frequency of vibration), for example, as shown in FIG. 7, and/or one or more tables including numeric values corresponding to the vibration-related information (e.g., tables including frequency values and corresponding acceleration values). As shown in FIG. 7, a Y-axis depicts the magnitude of the acceleration associated with operation of the rotary machine (in Gs (fractions or multiples of acceleration due to gravitational force)), and the X-axis shows the frequencies (in hertz (Hz)) at which the accelerations occur. In this example graphical manner, vibration-related information associated with rotary machine during operation may be shown (e.g., displayed on output device 134 associated with case 200), and/or transmitted to remote facility 168 (see FIG. 1).

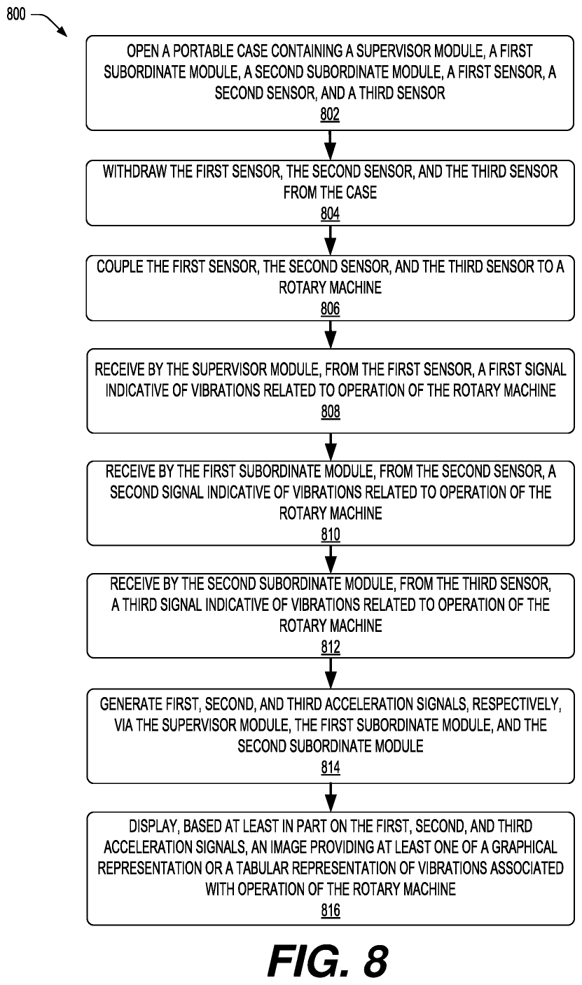

FIG. 8 illustrates an example process for acquiring vibration-related information associated with operation of a rotary machine. This process is illustrated as a logical flow graph, operation of which represents a sequence of operations, at least some of which may be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process.

FIG. 8 illustrates a flow diagram of an example process 800 for acquiring vibration-related information associated with operation of a rotary machine. The following actions described with respect to FIG. 8 may be performed, for example, as illustrated with respect to FIGS. 1-7.

The example process 800, at 802, may include opening a portable case containing a supervisor module, a first subordinate module, a second subordinate module, a first sensor, a second sensor, and a third sensor. For example, the portable case may be transported via a user to a remote worksite, such as, for example, a construction site or a mining site, at which a rotary machine is present. As explained herein, the case and components may be light enough for a person to carry the case and components, for example, without the assistance of a vehicle. In some examples, one or more batteries may be included in the case. Thus, in some examples, the process 800 may be carried out at a location remote from an external electrical power supply.

At 804, the example process 800 may include withdrawing the first sensor, the second sensor, and the third sensor from the case. For example, the case may be opened to access one or more of the sensors, which may be withdrawn from the case so that they may be used to acquire vibration-related information associated with operation of the rotary machine to which the case has been transported.

The example process 800 may also include, at 806, coupling the first sensor, the second sensor, and the third sensor to a rotary machine. For example, one or more of the first, second, or third sensors may include a housing, and the housing may include a coupling device configured to detachably couple the one or more sensors to the rotary machine (e.g., directly to the rotary machine). For example, the housing(s) of the one or more sensors may include a magnetic coupling device, for example, as described herein, and the one or more sensors may be coupled to the rotary machine via the magnet(s). For example, if the rotary machine is an internal combustion engine, access may be gained to the exterior surface of the internal combustion engine, and one or more of the first, second, or third sensors may be coupled to the exterior surface of the internal combustion engine. In some examples of the process 800, the first, second, and third sensors may be single-axis accelerometers and may be coupled to the rotary machine, such that respective measurement axes of each of the first, second, and third sensors are substantially mutually orthogonal with respect to one another. In some examples, the sensors and/or respective housings may include an arrow identifying the measurement axis of each of the sensors (see, e.g., FIG. 1).

At 808, the example process 800 may include receiving by the supervisor module, from the first sensor, a first signal indicative of vibrations related to operation of the rotary machine. For example, the first sensor may be communicatively coupled to the supervisor module. The first sensor may generate one or more voltage signals corresponding to vibrations of the rotary machine during operation, and the supervisor module may be configured to convert the one or more voltage signals into one or more signals indictive of accelerations corresponding to the vibrations, for example, in an axis substantially aligned with the measurement axis of the first sensor.

The example process 800, at 810, may also include receiving by the first subordinate module, from the second sensor, a second signal indicative of vibrations related to operation of the rotary machine. For example, the second sensor may be communicatively coupled to the first subordinate module. The second sensor may generate one or more voltage signals corresponding to vibrations of the rotary machine during operation, and the first subordinate module may be configured to convert the one or more voltage signals into one or more signals indictive of accelerations corresponding to the vibrations, for example, in an axis substantially aligned with the measurement axis of the second sensor, which may be, in some examples, substantially orthogonal with respect to the measurement axis of the first sensor.

At 812, the example process 800 may further include receiving by the second subordinate module, from the third sensor, a third signal indicative of vibrations related to operation of the rotary machine. For example, the third sensor may be communicatively coupled to the second subordinate module. The third sensor may generate one or more voltage signals corresponding to vibrations of the rotary machine during operation, and the second subordinate module may be configured to convert the one or more voltage signals into one or more signals indictive of accelerations corresponding to the vibrations, for example, in an axis substantially aligned with the measurement axis of the third sensor, which may be, in some examples, substantially orthogonal with respect to the measurement axis/axes of the first sensor and/or the second sensor.

The example process 800, at 814, may also include generating a first acceleration signal, a second acceleration signal, and a third acceleration signal respectively via the supervisor module, the first subordinate module, and the second subordinate module, for example, as described above.

At 816, the example process 800 may also include displaying, based at least in part on the first acceleration signal, the second acceleration signal, and the third acceleration signal, an image providing at least one of a graphical representation of vibration associated with operation of the rotary machine or a tabular representation of vibration associated with operation of the rotary machine. For example, the second acceleration signal and/or the third acceleration signal may be communicated to the supervisor module, and the supervisor module may generate image data for communication to an output device, such as, for example, a display device. The image data may be configured to result in display of a graphical representation of the first, second, and/or third acceleration signals, for example, in a single graph, two graphs, and/or three graphs. In some examples, the image data may be configured to result in display of a tabular representation of the first, second, and/or third acceleration signals, for example, in a single table, two tables, and/or three tables. In some examples, the graphical and/or tabular representations may show magnitude of vibration versus corresponding frequencies of vibration associated with operation of the rotary machine.

In some examples, the process 800 may also include transmitting at least one of the image, the first acceleration signal, the second acceleration signal, or the third acceleration signal to a location remote from the case. For example, the system may include a transmitter configured to transmit the vibration-related related information, via communications cable and/or via wireless communication, to a remote facility such as an on-site maintenance location and/or to a maintenance location and/or service location remote from the worksite, such as a location associated with the manufacturer and/or distributor of the rotary machine.

In some examples, the process 800 may further include identifying differences between vibrational data associated with prior-in-time operation of the rotary machine and the first acceleration signals, the second acceleration signals, and/or the third acceleration signals, for example, as explained herein. In some examples, the process 800 may also include determining that the differences are an indication of a fault associated with the rotary machine, for example, as explained herein. In some examples, identifying the differences may include accessing memory configured to store vibrational data associated with prior-in-time operation of the rotary machine, and identifying differences between the vibrational data associated with prior-in-time operation of the rotary machine and at least one of the first acceleration signals, the second acceleration signals, or the third acceleration signals. This may be performed manually by a human and/or automatically via a system configured to identify such differences, such as one or more computer systems executing software configured to perform such operations.

### INDUSTRIAL APPLICABILITY

The exemplary systems and related methods for acquiring vibration-related information associated with operation of a rotary machine may be applicable to a variety of rotary machines, for example, any machine having components that rotate and/or revolve during operation of the rotary machine. For example, the systems and methods may be applicable to internal combustion engines, such as, for example, reciprocating-piston engines and gas turbine engines, electric generators, electric motors, compressors, and pumps. The systems and methods, in some examples, may render is possible to identify one or more potential faults (e.g., rotational imbalance, component fracture, component wear, and/or excessive heat build-up) of one or more components of a rotary machine, for example, as explained herein. Thus, the systems and methods may be used to identify a problem with one or more components of the rotary machine prior to failure, which may reduce or prevent damage to additional components of the rotary machine, thereby potentially reducing down time and/or repair costs associated with repair of the rotary machine. For example, failure of some components of the rotary machine may result in damage to additional, and sometimes more-costly, components. However, identification of problems prior to failure of the component at issue may render it possible to replace and/or repair only the component at issue prior to damage occurring to additional components. In some examples, the systems and methods described herein may be used to acquire vibration-related data that may be used to identify problems before they result in damage to additional components of the rotary machine, for example, as described herein. This may reduce machine down time and costs associated with maintenance and/or repair of the rotary machine.

In addition, or alternatively, the systems and methods described herein, in some examples, may result in a portable system that may be used, for example, without an external electrical power source. For example, some examples of the system may include one or more batteries, for example, as described herein, rendering it possible to use the system in a remote location without the use of an external electrical power source. This may render it possible for use of the system at a remote worksite, such as, for example, a construction worksite or a mining worksite. In some examples, operation of the system may be performed by personnel that have not been trained to use the system, and thus, a customer using a rotary machine may use the system and/or method to identify potential, impending, and/or existing problems with the rotary machine, for example, prior to more costly damage to the rotary machine. This may result in increasing the likelihood that the operator of the rotary machine detects faults with the rotary machine prior to severe damage to the offending component and/or prior to additional components being damaged. In some examples, the systems and methods may render it possible to determine that the rotary machine is operating properly (e.g., according to specification) without unnecessarily expending the time and/or cost associated with transporting the rotary machine to a maintenance or service facility remote from the location at which the rotary machine is being used.

In some examples, the vibration-related information that may be acquired by the systems and methods described herein may be compared to similar data recorded while the rotary machine is operated in a fault-free manner (e.g., according to specification). For example, the similar vibration-related data for the rotary machine, or other rotary machines of the same or similar model, may be stored in a data base for comparison to vibration-related data obtained via some examples of the systems and methods described herein. Differences between the stored vibration-related data may be identified, for example, manually and/or automatically via a computer system, and the differences may be used to determine whether the rotary machine may have a potential or actual fault with one or more of its components.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of what is disclosed. Such embodiments should be understood to fall within the scope of the present disclosure as determined based upon the claims and any equivalents thereof.

What is claimed is:

1. A system for acquiring vibration-related information associated with operation of a rotary machine, the system comprising:
a portable case configured to contain therein, and facilitate access to, components of the system;
a first sensor configured to be detachably coupled to a rotary machine and generate a first signal indicative of vibrations related to operation of the rotary machine;
a supervisor module in communication with the first sensor and configured to receive the first signal indicative of vibrations related to operation of the rotary machine and generate a first acceleration signal based at least in part on the first signal indicative of vibrations related to operation of the rotary machine;
a second sensor configured to be detachably coupled to the rotary machine and generate a second signal indicative of vibrations related to operation of the rotary machine;
a first subordinate module in communication with the supervisor module and the second sensor and configured to receive the second signal indicative of vibrations related to operation of the rotary machine and generate a second acceleration signal based at least in part on the second signal indicative of vibrations related to operation of the rotary machine;
a third sensor configured to be detachably coupled to the rotary machine and generate a third signal indicative of vibrations related to operation of the rotary machine;
a second subordinate module in communication with the supervisor module and the third sensor and configured to receive the third signal indicative of vibrations related to operation of the rotary machine and generate a third acceleration signal based at least in part on the third signal indicative of vibrations related to operation of the rotary machine; and
an output device in communication with the supervisor module,
wherein the supervisor module is configured to:
provide operation instructions to the first subordinate module and to the second subordinate module;
receive the second acceleration signal from the first subordinate module and the third acceleration signal from the second subordinate module; and
communicate image data indicative of the first acceleration signal, the second acceleration signal, and the third acceleration signal to the output device.

2. The system of claim 1, further comprising a primary battery configured to supply electrical power to the system from within the case, and a secondary battery configured to supply electrical power to the system from within the case when a level of charge of the primary battery drops below a threshold level of charge.

3. The system of claim 1, further comprising:
a first data acquisition module in communication with the first sensor and the supervisor module;
a second data acquisition module in communication with the second sensor and the first subordinate module; and
a third data acquisition module in communication with the third sensor and the second subordinate module,
wherein the first data acquisition module, the second data acquisition module, and the third data acquisition module are configured to at least one of: regulate power associated with the first sensor, the second sensor, and the third sensor, or regulate frequencies at which the first sensor, the second sensor, and the third sensor generate, respectively, the first signal, the second signal, and the third signal.

4. The system of claim 1, wherein the operation instructions comprise a timestamp for temporally aligning the first signal, the second signal, and the third signal.

5. The system of claim 1, further comprising a user input device configured to facilitate selection of one of a standard operation mode and user-defined operation mode.

6. The system of claim 5, wherein the standard operation mode comprises at least one of a predetermined testing duration, a predetermined testing delay, a predetermined test frequency, or a predetermined voltage offset, and the user-defined operation mode comprises at least one of a user-defined testing duration, a user-defined testing delay, a user-defined test frequency, or a user-defined voltage offset.

7. The system of claim 1, further comprising a communication hub in communication with the supervisor module, the first subordinate module, and the second subordinate module, and configured to:
receive the first acceleration signal, the second acceleration signal, and the third acceleration signal; and
communicate the first acceleration signal, the second acceleration signal, and the third acceleration signal to the supervisor module.

8. The system of claim 1, wherein the image data indicative of the first acceleration signal, the second acceleration signal, and the third acceleration signal is indicative of at least one of a graphical representation of vibration associated with operation of the rotary machine or a tabular representation of vibration associated with operation of the rotary machine.

9. The system of claim 1, wherein at least one of the first sensor, the second sensor, and the third sensor comprises a single-axis accelerometer, and wherein the system further comprises at least one sensor housing comprising a magnetic coupler configured to detachably couple at least one of the first sensor, the second sensor, or the third sensor to the rotary machine.

10. The system of claim 1, wherein the supervisor module is configured to:
access memory configured to store vibrational data associated with prior-in-time operation of the rotary machine; and
identify differences between the vibrational data associated with prior-in-time operation of the rotary machine and at least one of the first acceleration signal, the second acceleration signal, or the third acceleration signal.

11. The system of claim 1, further comprising a transmitter configured to transmit at least one of the image data, the first acceleration signal, the second acceleration signal, or the third acceleration signal to a location remote from the case.

12. A system for acquiring vibration-related information associated with operation of a rotary machine, the system comprising:
a case configured to contain therein, and facilitate access to, components of the system;
a sensor configured to be detachably coupled to a rotary machine and generate a signal indicative of vibrations related to operation of the rotary machine;
a supervisor module in communication with the sensor and configured to receive the signal indicative of vibrations related to operation of the rotary machine and generate a first acceleration signal based at least in part on the signal indicative of vibrations related to operation of the rotary machine;
a subordinate module in communication with the supervisor module and the sensor and configured to receive the signal indicative of vibrations related to operation of the rotary machine and generate a second acceleration signal based at least in part on the signal indicative of vibrations related to operation of the rotary machine; and
an output device in communication with the supervisor module,
wherein the supervisor module is configured to:
provide operation instructions to the subordinate module;
receive the second acceleration signal from the subordinate module; and
communicate image data indicative of the first acceleration signal, and the second acceleration signal to the output device.

13. The system of claim 12, further comprising a primary battery configured to supply electrical power to the system from within the case, and a secondary battery configured to supply electrical power to the system from within the case when a level of charge of the primary battery drops below a threshold level of charge.

14. The system of claim 12, wherein the operation instructions comprise a timestamp for temporally aligning the first acceleration signal and the second acceleration signal.

15. The system of claim 12, further comprising a transmitter configured to transmit at least one of the image data, the first acceleration signal or the second acceleration signal to a location remote from the case.

16. A method for acquiring vibration-related information associated with operation of a rotary machine, the method comprising:
opening a portable case containing a supervisor module, a first subordinate module, a second subordinate module, a first sensor, a second sensor, and a third sensor;
withdrawing the first sensor, the second sensor, and the third sensor from the case;
coupling the first sensor, the second sensor, and the third sensor to a rotary machine;
receiving by the supervisor module, from the first sensor, a first signal indicative of vibrations related to operation of the rotary machine;
receiving by the first subordinate module, from the second sensor, a second signal indicative of vibrations related to operation of the rotary machine;
receiving by the second subordinate module, from the third sensor, a third signal indicative of vibrations related to operation of the rotary machine;
generating a first acceleration signal, a second acceleration signal, and a third acceleration signal respectively via the supervisor module, the first subordinate module, and the second subordinate module; and
displaying, based at least in part on the first acceleration signal, the second acceleration signal, and the third acceleration signal, an image providing at least one of a graphical representation of vibration associated with operation of the rotary machine or a tabular representation of vibration associated with operation of the rotary machine.

17. The method of claim 16, further comprising transmitting at least one of the image, the first acceleration signal, the second acceleration signal, or the third acceleration signal to a location remote from the case.

18. The method of claim 16, further comprising identifying differences between vibrational data associated with prior-in-time operation of the rotary machine and the first acceleration signal, the second acceleration signal, and the third acceleration signal.

19. The method of claim 18, further comprising determining that the differences are an indication of a fault associated with the rotary machine.

20. The method of claim 18, wherein identifying the differences comprises:
accessing memory configured to store vibrational data associated with prior-in-time operation of the rotary machine; and
identifying differences between the vibrational data associated with prior-in-time operation of the rotary machine and at least one of the first acceleration signal, the second acceleration signal, or the third acceleration signal.
